(19) United States
(12) Patent Application Publication
(10) Pub. No.: US 2019/0375078 A1
(43) Pub. Date: Dec. 12, 2019

(54) IMPACT BLOCK, CARRIER MEMBER AND IMPACT TOOL USING SAMES

(71) Applicant: TRANMAX MACHINERY CO., LTD., Taichung City (TW)

(72) Inventor: Hsin-Chi CHEN, Taichung City (TW)

(21) Appl. No.: 16/146,182

(22) Filed: Sep. 28, 2018

(30) Foreign Application Priority Data
Jun. 12, 2018 (TW) 107120198
Jun. 27, 2018 (TW) 107122081
Sep. 21, 2018 (TW) 107133434

(51) Int. Cl. B25B 21/02; B25F 5/00

(52) U.S. Cl. CPC B25B 21/02; B25F 5/006

(57) ABSTRACT

An impact block, a carrier member mating the impact block and an impact tool using the impact block and the mating carrier member are disclosed. The impact block includes an annular body including an outer race, an inner race, a positioning portion provided with the outer race for bump fit and extending in the axial direction of the annular body and one or multiple impact portion provided with the inner race. By using the impact tool composed of the above impact block and the matching carrier member, the vibration generated by the striking process can be reduced, the striking efficiency is improved, the service life is increased, the component composition is simplified, the assembly procedure is quick and simple.

### BACKGROUND OF THE INVENTION

### 1. Field of the Invention

The present invention relates to power tool technology, and more particularly to an impact block, a mating carrier member and an impact tool using the impact block and the carrier member.

### 2. Description of the Related Art

In order to make the pneumatic tools or electric tools have greater torque and impact force, impact power tools made by adding an impact tool to simple power tools become common repair tools.

Various impact tools for power tool are known. For the advantages of capable of delivering more torque and having a high structural strength, the twin-hammer impact tool composed of two annular impact blocks and a rotary shaft has been widely used in different pneumatic tools.

U.S. Pat. No. 6,491,111 discloses a rotary impact tool having a twin hammer mechanism that generally includes a carrier member, a pair of hollow hammer members 40 pivotally positioned in a channel 38 within the carrier member 20 by a respective pin so the hollow hammer members 40 rotate with the carrier member under drive from an air motor output shaft.

However, the composition of the aforementioned twin-hammer impact tool is still relatively complicated, the assembly is not easy, the service life is also short, and the vibration is large when used, and the operability cannot meet the needs of use. An improvement is needed.

### SUMMARY OF THE INVENTION

The present invention has been accomplished under the circumstances in view. It is the main object of the present invention to provide an impact block, a carrier member and an impact tool using the impact block and the carrier member, which reduces vibration during striking, improves striking efficiency, prolongs service life, simplifying component composition and facilitating quick assembly.

To achieve this and other objects of the present invention, an impact block for impact tool comprises an annular body. The annular body comprises an outer race, an inner race, a positioning portion provided with the outer race for bump fit and extending in the axial direction of the annular body, and at least one impact portion provided with the inner race.

To achieve this and other objects of the present invention, a carrier member comprises bottom portion, a circumferential wall provided on the bottom portion and a chamber formed between the bottom portion and the circumferential wall. The positioning portion of the impact block is pivotally connected to the circumferential wall within the chamber to let the impact block be disposed inside the chamber.

To achieve this and other objects of the present invention, an impact tool comprises the aforesaid carrier member, at least one above-described impact block pivotally mounted within the chamber of the carrier member, and a rotary shaft coaxially mounted with the at least one impact block within the chamber of the carrier member. The rotary shaft comprises a bottom end disposed on the bottom portion of the carrier member. The positioning portion of the impact block is pivotally connected to the circumferential wall of the carrier member corresponding to an inner circumferential surface of the chamber. Since the positioning portion of the impact block is integrally formed on the annular body and pivotally connected to the inside of the carrier member by bump fit, the vibration generated by the striking process can be reduced, the striking efficiency is improved, the service life is increased, the component composition is simplified, the assembly procedure is quick and simple.

Preferably, the impact tool further comprises an end cover capped on the circumferential wall to enclose the chamber. Thus, the cooling lubricant inside the carrier member is not worn out or spilled outward, and the overall service life of the impact tool can be increased.

Preferably, the impact tool further comprises a pin axially connected between the bottom end of the rotary shaft and a motor driving shaft that is inserted through the bottom portion of the carrier member and connected to the bottom end of the rotary shaft.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an oblique elevational view of an impact tool in accordance with a first embodiment of the present invention.

FIG. 2 is an exploded view of the impact tool shown in FIG. 1.

FIG. 3 is a side view of the impact tool shown in FIG. 1.

FIG. 4 is a sectional view taken along line 4-4 of FIG. 3.

FIG. 5 is a cross-sectional view of the carrier member of the impact tool in accordance with the first embodiment of the present invention.

FIG. 6 is a cross-sectional view of the impact block of the impact tool in accordance with the first embodiment of the present invention.

FIG. 7 is a sectional view taken along line 7-7 of FIG. 3.

FIG. 8 is a sectional view taken along line 8-8 of FIG. 3.

FIG. 9 is an exploded view of an alternate form of the impact tool in accordance with the first embodiment of the present invention.

FIG. 10 is an exploded view of another alternate form of the impact tool in accordance with the first embodiment of the present invention.

FIG. 11 is similar to FIG. 7, illustrating an alternate form of the impact tool in accordance with the first embodiment of the present invention.

FIG. 12 is an exploded view of still another alternate form of the impact tool in accordance with the first embodiment of the present invention.

FIG. 13 is an exploded view of an impact tool in accordance with a second embodiment of the present invention.

### DETAILED DESCRIPTION OF THE INVENTION

The invention provides an impact block for impact tool, a carrier member for carrying the impact block and an impact tool using the impact block and the carrier member. The invention can be applied to a power tool mainly driven by a pneumatic motor or an electric motor, and the driving shaft of the motor can drive the impact tool to generate a rotation and a striking effect. The impact block of the present invention can be widely applied to various impact tools and power tools.

Those skilled in the art should be able to understand that the description of the present preferred embodiment is a generic description that does not limit the application field. For example, the terms such as a combination, a connection relationship, or a directional relationship are merely examples, and the number of components “one” includes one and more than one number of complex components.

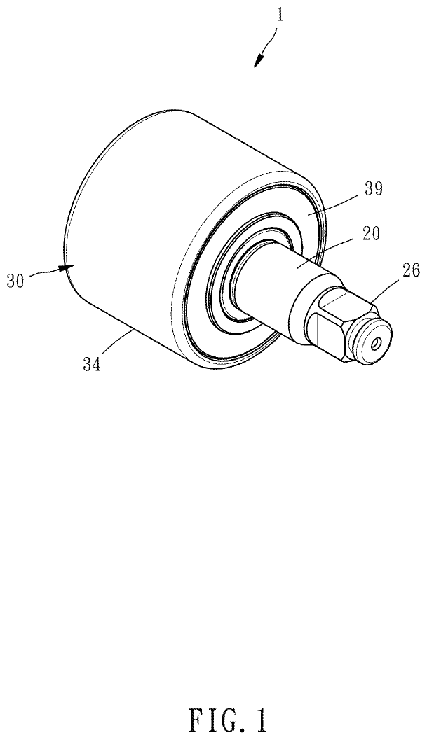

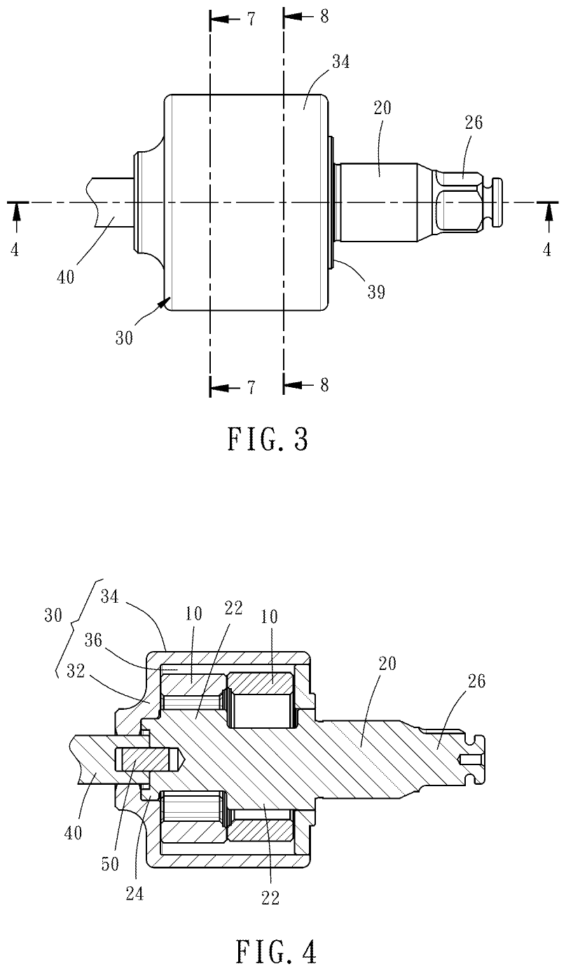

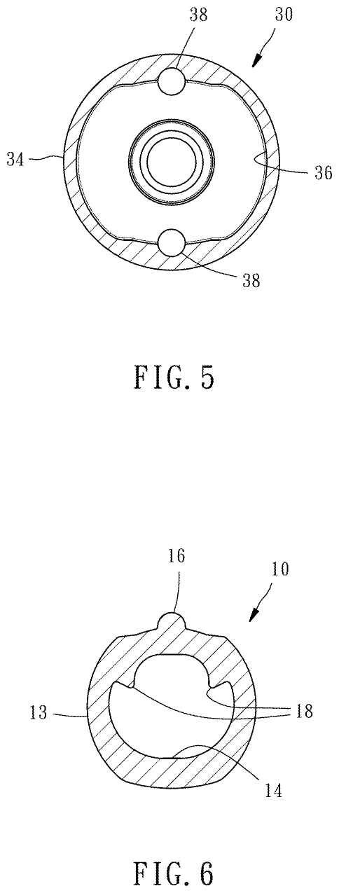

Referring to FIGS. 1-6, an impact block 10 for impact tool 1 in accordance with a first embodiment of the present invention generally comprises an annular body 12. The annular body 12 defines an outer race 13, an inner race 14 and two opposing end faces 15. As illustrated in FIG. 6, the outer race 13 is provided with a first positioning portion 16 for bump fit. In the present preferred embodiment, the first positioning portion 16 is exemplified by a convex shape. The first positioning portion 16 extends along the axial direction of the annular body 12 between the two end faces 15. The inner race 14 is provided with at least one impact portion 18, and the at least one impact portion 18 of the preferred embodiment is formed of two opposing claw-shaped regions.

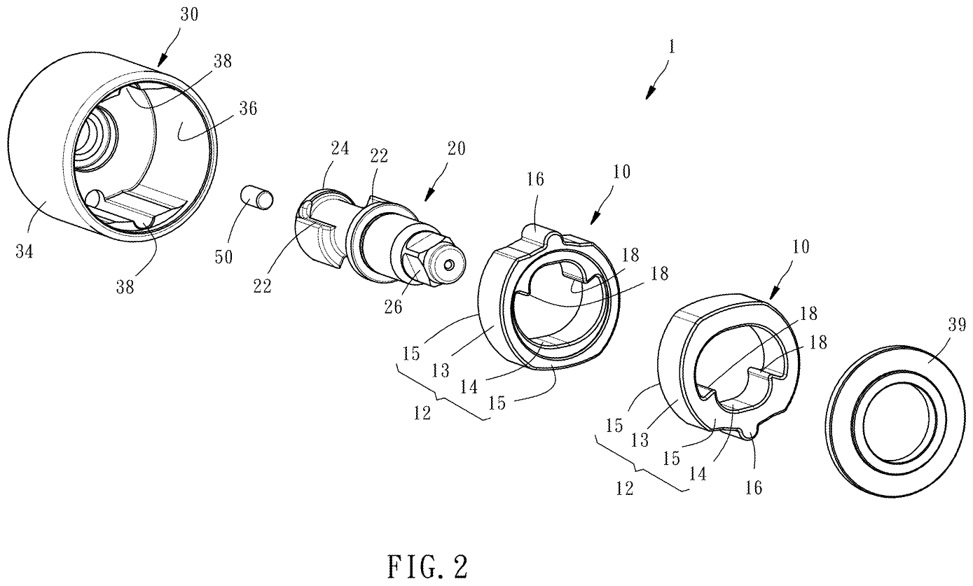

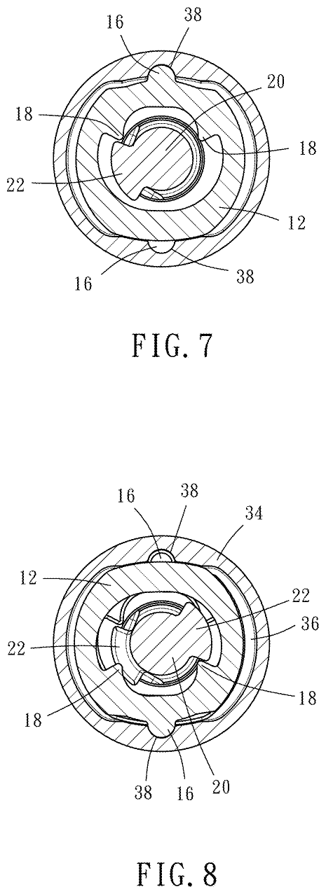

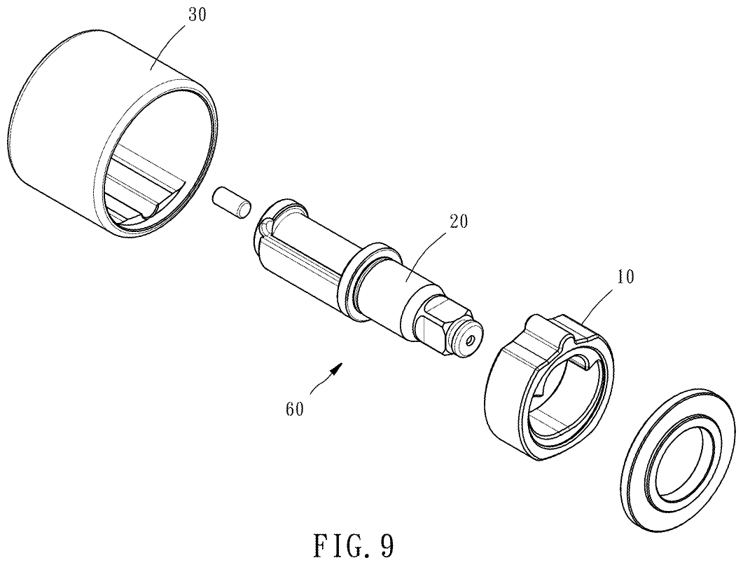

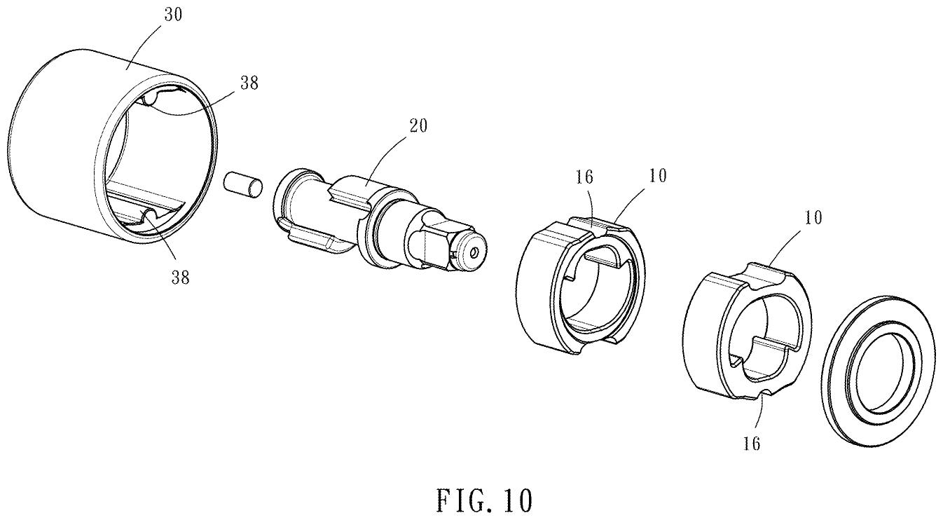

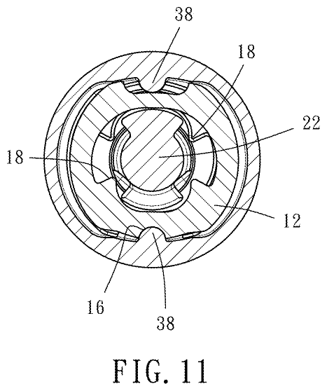

The impact tool 1 provided by the preferred embodiment of the present invention includes two impact blocks 10 coaxially arranged in a 180 degree up and down symmetric relationship. As illustrated in FIG. 2, the two impact blocks 20 are mounted around a rotary shaft 20 in the same axial direction with the end faces 15 of one impact block 20 disposed in parallel to that of the other. The outer peripheral surface of the rotary shaft 20 has two mutually spaced lugs 22. As shown in FIGS. 7 and 8, the lug 22 and the impact portion 18 of each of the impact blocks 10 can abut or separate from each other according to the change in the rotation angle. The rotary shaft 20 and the impact blocks 10 are coaxially mounted within a carrier member 30. As shown in FIGS. 2-5, the carrier member 30 is generally cylindrical, comprising a bottom portion 32, a circumferential wall 34 provided on the bottom portion 32 and a chamber 36 formed between the bottom portion 32 and the circumferential wall 34. The cross-sectional shape of the chamber 36 is approximately the same and slightly larger than the cross-sectional shape of the impact blocks 10. The circumferential wall 34 of the carrier member 30 is provided with two second positioning portions 38 corresponding to the inner circumferential surface of the chamber 36. The two second positioning portions 38 fit the first positioning portions 16 of the impact blocks 10 respectively. The second positioning portions 38 of the preferred embodiment are mutually symmetrical and directly recessed in the inner peripheral surface, each extending along the axial direction of the carrier member 30. In the example shown in FIG. 10 and FIG. 11, the first positioning portion 16 is a groove, and the second positioning portions 38 are convex shaped. Similarly, each impact block 10 can be disposed inside the carrier member 30.

As shown in FIGS. 2-8, the two impact blocks 10 and the rotary shaft 20 are directly disposed inside the chamber 36 of the carrier member 30 with an inner end 24 of the rotary shaft 20 abutted against the bottom portion 32 of the carrier member 30 and the first positioning portion 16 of each impact block 10 fitting into one respective second positioning portion 38 of the carrier member 30. Further, an end cover 39 is capped on an end edge of the circumferential wall 34 to enclose the chamber 36. A cooling lubricant can be applied to the inside of the chamber 36. The opposite outer end 26 of the rotary shaft 20 extends out of the end cover 39. Thus, the impact tool 1 is assembled. Each impact block 10 is pivoted with respect to the carrier member 30 by the first positioning portion 16 thereof that is pivotally inserted into the respective second positioning portion 38 of the carrier member 30. The motor driving shaft 40 of the power tool is inserted through the center of the bottom portion 32 of the carrier member 30 and connected with the inner end 24 of the rotary shaft 20. A pin 50 is axially connected between the inner end 24 of the rotary shaft 20 and the motor driving shaft 40 to increase the coaxiality between the motor driving shaft 40 and the rotary shaft 20, reducing transmission vibration.

With the above-described constituent component parts of the present invention, the motor driving shaft 40 can directly drive the carrier member 30 to rotate. Through the pivoting between the first positioning portions 16 of the impact blocks 10 and the respective second positioning portions 38 of the carrier member 30, the impact blocks 10 are biased into contact with or away from the respective lugs 22 of the rotary shaft 20 to generate torque or impact. Since the first positioning portion 16 is directly and integrally formed on the outer race 13 of the impact block 10 for bump fit and the first positioning portion 16 is directly and pivotally connected to the respective second positioning portion 38, the composition of the invention is simplified, the assembly procedure is quick and simple, the vibration of the striking process is reduced, and the striking efficiency is improved. Furthermore, since the chamber 36 of the carrier member 30 is closed, the cooling lubricant inside the carrier member 30 is not worn out or spilled outward, and the overall service life of the impact tool 1 can be increased.

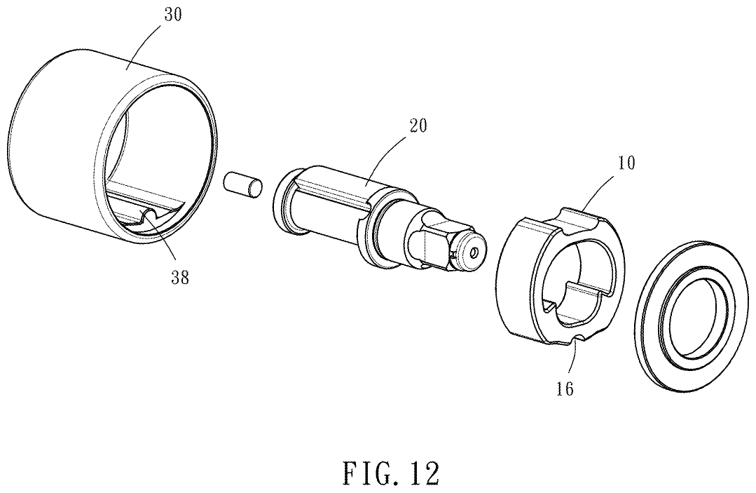

Referring to FIGS. 9-12, the impact tool, referenced by 60, simply comprises one single impact block 10. The first positioning portion 16 of the impact block 10 and the second positioning portion 38 of the carrier member 30 are configured for bump fit with one in the form of a groove and the other in the form of a convex shape.

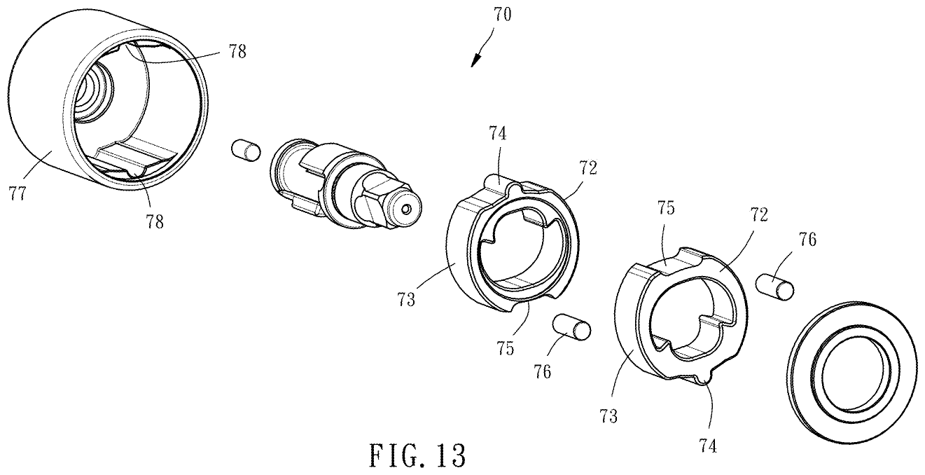

Referring to FIG. 13, an impact tool 70 in accordance with a second embodiment of the present invention is substantially similar to the aforesaid first embodiment with the exceptions outlined hereinafter. Each impact block 72 comprises a groove 75 located on the outer race 73 thereof opposite to the first positioning portion 74, and a position-limiting member 76 mounted in the groove 75. The position-limiting member 76 in this embodiment is a round pin as an example. The position-limiting member 76 is disposed between the impact block 72 and the carrier 77 and partially engaged in the second positioning portion 78 that corresponds to the carrier 77. The opening size and angle of the groove 75 can be adjusted according to the torque generated by the impact tool 70, so that when each impact block 72 is impacting, it is stopped against the position-limiting member 76 and will not be excessively biased and prohibited from striking against the inside wall of the carrier, increasing torque stability and reducing vibration and operating noise.

1. An impact block for impact tool, comprising an annular body, said annular body comprising an outer race and an inner race, said outer race providing with a positioning portion for bump fit, said positioning portion extending along the axial direction of said annular body, said inner race providing with at least one impact portion.

2. The impact block as claimed in claim 1, wherein said annular body further comprises two opposing end faces; said positioning portion extends between said two end faces.

3. A carrier member for carrying the impact block as claimed in claim 1, comprising a bottom portion, a circumferential wall provided on said bottom portion and a chamber formed between said bottom portion and said circumferential wall; said positioning portion of said impact block is pivotally connected to said circumferential wall within said chamber to let said impact block be disposed inside said chamber.

4. The carrier member as claimed in claim 3, wherein said circumferential wall of said carrier member is provided with at least one second positioning portion corresponding to an inner circumferential surface of said chamber for bump fit, said at least one second positioning portion extending along the axial direction of said carrier member and configured to fit said positioning portion of said impact block.

5. The carrier member as claimed in claim 3, further comprising an end cover capped on said circumferential wall to enclose said chamber.

6. An impact tool comprising at least one impact block as claimed in claim 1.

7. An impact tool comprising a carrier member as claimed in claim 3.

8. An impact tool, comprising:
a carrier member as claimed in claim 3;
at least one impact block comprising an annular body, said annular body comprising an outer race and an inner race, said outer race providing with a positioning portion for bump fit, said positioning portion extending along the axial direction of said annular body, said inner race providing with at least one impact portion pivotally mounted within the said chamber of said carrier member; and
a rotary shaft comprising a bottom end, said rotary shaft being coaxially mounted with said at least one impact block within said chamber of said carrier member, said bottom end being disposed on said bottom portion of said carrier member;
wherein the said positioning portion of each said impact block is pivotally connected to said circumferential wall of said carrier member corresponding to an inner circumferential surface of said chamber.

9. The impact tool as claimed in claim 8, further comprising a pin axially connected between said bottom end of said rotary shaft and a motor driving shaft that is inserted through said bottom portion of said carrier member and connected to said bottom end of said rotary shaft.

10. The impact tool as claimed in claim 8, wherein each said impact block comprises a groove located on the outer race thereof opposite to said first positioning portion, and a position-limiting member mounted in said groove between said at least one impact block and said carrier.
